(19) United States
(12) Patent Application Publication
(10) Pub. No.: US 2026/0274071 A1
(43) Pub. Date: Sep. 17, 2026

(54) CONTENT CONTROL DEVICE, CONTENT CONTROL METHOD, AND STORAGE MEDIUM

(71) Applicant: HONDA MOTOR CO., LTD., Tokyo (JP)

(72) Inventor: Takashi Noguchi, Tokyo (JP)

(21) Appl. No.: 19/443,687

(22) Filed: Jan. 8, 2026

(30) Foreign Application Priority Data
Mar. 13, 2025 (JP) 2025-039998

(51) Int. Cl. B60K 35/28; B60K 35/29; H04N 21/414; H04N 21/442

(52) U.S. Cl. CPC B60K 35/28; B60K 35/29; H04N 21/41422; H04N 21/44227

(57) ABSTRACT

A content control device includes: a content output unit that outputs a content to a passenger seated on a seat of a vehicle; an output status acquisition unit that acquires an output status of the content being output by the content output unit; a content acquisition unit that acquires the content via a communication interface; a communication state estimation unit that estimates a communication state of the communication interface; a content storage unit that stores the acquired content; and a notification unit that notifies the passenger of information related to the content, and the notification unit varies a notification content depending on the output status of the content acquired by the output status acquisition unit and the communication state estimated by the communication state estimation unit.

### INCORPORATION BY REFERENCE

The present application claims priority under 35 U.S.C. § 119 to Japanese Patent Application No. 2025-039998 filed on Mar. 13, 2025. The content of the application is incorporated herein by reference in its entirety.

### BACKGROUND OF THE INVENTION

### Field of the Invention

The present invention relates to a content control device, a content control method, and a storage medium.

### Description of the Related Art

Japanese Patent Laid-Open No. 2003-61149 discloses a technique for storing the amount of data, which would otherwise run short in a section where a radio wave environment is poor, in a buffer in the preceding section where the radio wave environment is good.

In the invention disclosed in Japanese Patent Laid-Open No. 2003-61149, however, a passenger of a vehicle may not be able to recognize a content to be downloaded when a communication failure occurs.

In other words, when the communication failure occurs, there is a problem of notifying the passenger of the vehicle of appropriate content information.

### SUMMARY OF THE INVENTION

In order to achieve the above object, a first aspect of the present invention provides a content control device including: a content output unit that outputs a content to a passenger seated on a seat of a vehicle; an output status acquisition unit that acquires an output status of the content being output by the content output unit; a communication unit that communicates with an external device of the vehicle to acquire the content; a communication state estimation unit that estimates a communication state of the communication unit; a content storage unit that stores the content acquired by the communication unit; and a notification unit that notifies the passenger of information related to the content, in which, the notification unit varies a notification content depending on the output status of the content acquired by the output status acquisition unit and the communication state estimated by the communication state estimation unit.

In order to achieve the above object, a second aspect of the present invention provides a content control method performed by a content control device, the content control device including: a content output unit that outputs a content to a passenger seated on a seat of a vehicle; an output status acquisition unit that acquires an output status of the content being output by the content output unit; a communication unit that communicates with an external device of the vehicle to acquire the content; a communication state estimation unit that estimates a communication state of the communication unit; a content storage unit that stores the content acquired by the communication unit; and a notification unit that notifies the passenger of information related to the content, in which, the notification unit executes a notification step of varying a notification content depending on the output status of the content acquired by the output status acquisition unit and the communication state estimated by the communication state estimation unit.

In order to achieve the above object, a third aspect of the present invention provides a non-transitory computer readable storage medium storing a content control program that causes a processor provided in a content control device arranged in a vehicle to function as: a content output unit that outputs a content to a passenger seated on a seat of the vehicle; an output status acquisition unit that acquires an output status of the content being output by the content output unit; a communication unit that communicates with an external device of the vehicle to acquire the content; a communication state estimation unit that estimates a communication state of the communication unit; a content storage unit that stores the content acquired by the communication unit; and a notification unit that notifies the passenger of information related to the content, in which, the notification unit varies a notification content depending on the output status of the content acquired by the output status acquisition unit and the communication state estimated by the communication state estimation unit.

According to the content control device, the content control method, and the storage medium, it is possible to notify the passenger of the vehicle of appropriate content information when a communication failure occurs.

### BRIEF DESCRIPTION OF THE DRAWINGS

FIG. 1 is a plan view illustrating an example of a configuration of a vehicle mounted with a content control device according to a first embodiment;

FIG. 2 is a diagram illustrating an example of a configuration of the content control device according to the first embodiment;

FIG. 3 is a diagram illustrating a relation between a scheduled output period of a first content and a poor communication period;

FIG. 4 is a diagram illustrating a relation between a shortage period and a second content;

FIG. 5 is a diagram illustrating a notification content;

FIG. 6 is a flowchart illustrating an example of processing of the content control device according to the first embodiment;

FIG. 7 is a plan view illustrating an example of a configuration of a vehicle mounted with a content control device according to a second embodiment;

FIG. 8 is a diagram illustrating an example of a configuration of the content control device according to the second embodiment;

FIG. 9 is a diagram illustrating a relation between a seat and a priority; and

FIG. 10 is a flowchart illustrating an example of processing of the content control device according to the second embodiment.

### DETAILED DESCRIPTION OF THE INVENTION

Hereinafter, embodiments of a content control device, a content control method, and a content control program will be described with reference to the drawings.

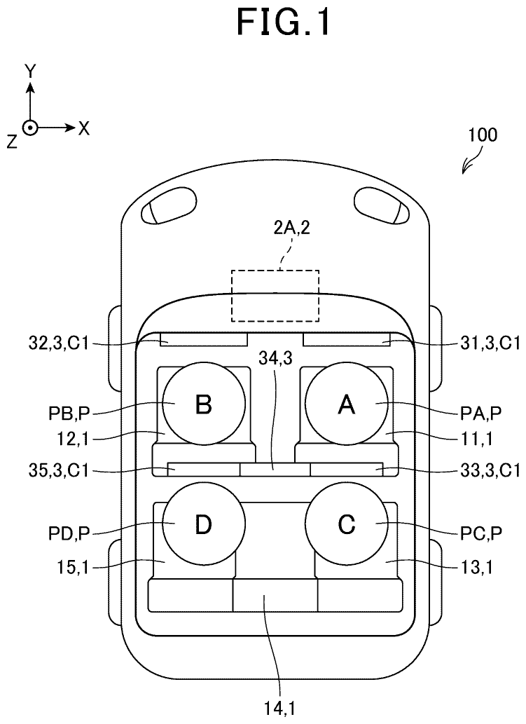

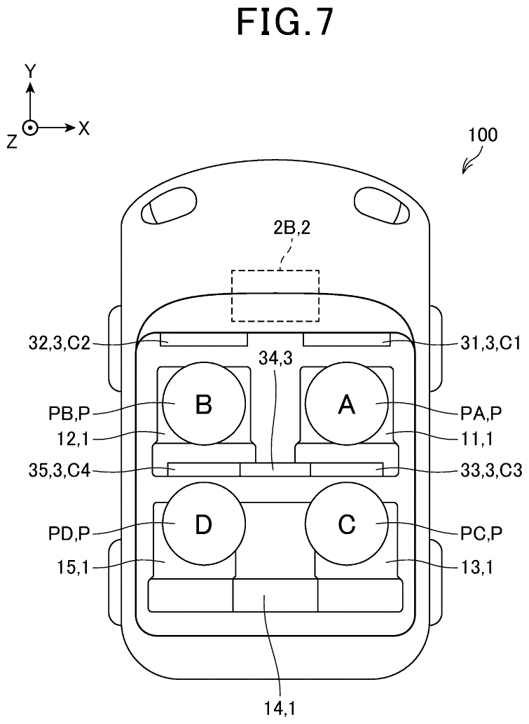

A content control device 2 includes a content control device 2A according to a first embodiment described with reference to FIGS. 1 to 6 and a content control device 2B according to a second embodiment described with reference to FIGS. 7 to 10.

### FIRST EMBODIMENT

### 1-1. Configuration of Vehicle

First, a configuration of a vehicle 100 mounted with a content control device 2A according to a first embodiment will be described with reference to FIG. 1. FIG. 1 is a plan view illustrating an example of the vehicle 100 mounted with the content control device 2A according to the first embodiment.

FIG. 1 illustrates an X-axis, a Y-axis, and a Z-axis that are orthogonal to each other. The X-axis and the Y-axis are parallel to a horizontal direction. The Z-axis is parallel to a vertical direction. The X-axis is parallel to a left-right direction of the vehicle 100. The Y-axis is parallel to a front-rear direction of the vehicle 100. A positive direction of the X-axis indicates a right direction of the vehicle. A positive direction of the Y-axis indicates a front direction of the vehicle. A positive direction of the Z-axis indicates an upward direction of the vehicle.

FIG. 1 illustrates a plan view of the vehicle 100 being in a state where a roof is removed.

As illustrated in FIG. 1, the vehicle 100 includes a seat 1, a content control device 2A, and an output mechanism 3.

In the present embodiment, the seat 1 is composed of a first seat 11, a second seat 12, a third seat 13, a fourth seat 14, and a fifth seat 15.

The first seat 11 and the second seat 12 are arranged at a front part in the vehicle 100. The first seat 11 and the second seat 12 constitute front seats. The third seat 13, the fourth seat 14, and the fifth seat 15 are arranged behind the first seat 11 and the second seat 12 in the vehicle 100. The third seat 13, the fourth seat 14, and the fifth seat 15 constitute back seats.

The first seat 11 is a driver's seat arranged on a right side in the front seats. A passenger PA is seated on a seat on the first seat 11. The passenger PA is a driver. In the present embodiment, the driver is included in the passenger P.

The second seat 12 is a passenger seat arranged to a left of the first seat 11. In the present embodiment, the passenger PB is seated on the second seat 12.

The third seat 13 is a seat arranged on the right side in the back seats. In the present embodiment, the passenger PC is seated on the third seat 13.

The fourth seat 14 is a seat arranged in a center part in the back seats. In the present embodiment, the passenger P is not seated on the fourth seat 14.

The fifth seat 15 is a seat arranged on the left side in the back seats. In the present embodiment, the passenger PD is seated on the fifth seat 15.

In the following description, the first seat 11, the second seat 12, the third seat 13, the fourth seat 14, and the fifth seat 15 may be referred to as a seat 1 unless otherwise distinguished from one another.

The output mechanism 3 is composed of a first output mechanism 31, a second output mechanism 32, a third output mechanism 33, a fourth output mechanism 34, and a fifth output mechanism 35.

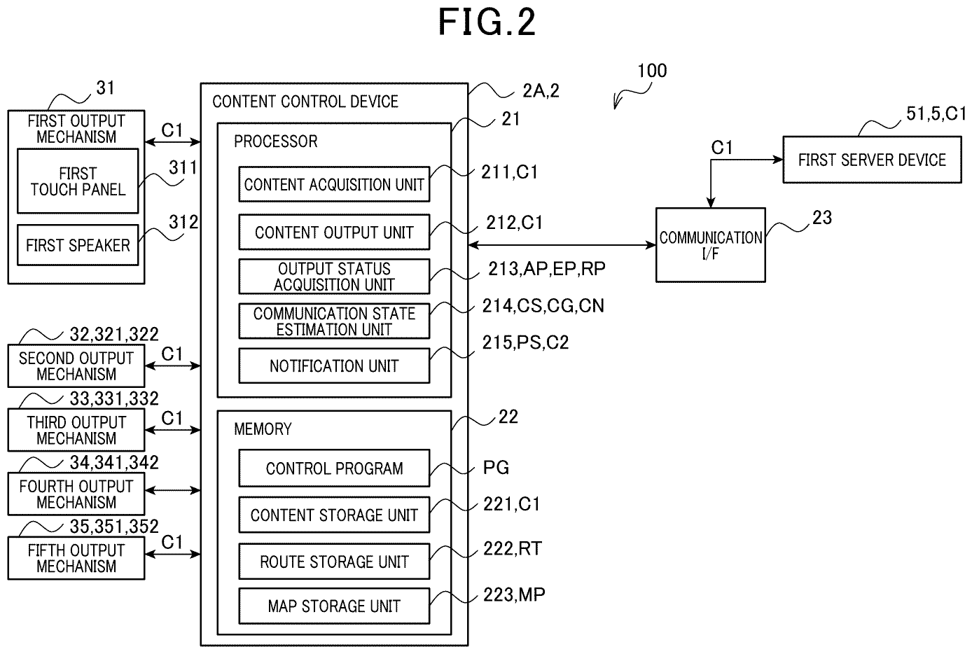

As described with reference to FIG. 2, the first output mechanism 31 includes a first touch panel 311 and a first speaker 312. The second output mechanism 32 includes a second touch panel 321 and a second speaker 322. The third output mechanism 33 includes a third touch panel 331 and a third speaker 332. The fourth output mechanism 34 includes a fourth touch panel 341 and a fourth speaker 342. The fifth output mechanism 35 includes a fifth touch panel 351 and a fifth speaker 352.

The first output mechanism 31 is arranged on a dashboard in front of the first seat 11, for example. The first touch panel 311 of the first output mechanism 31 is arranged such that a display screen thereof faces the passenger PA. In other words, the first touch panel 311 of the first output mechanism 31 is arranged such that the display screen faces rearward.

The first touch panel 311 and the first speaker 312 output a content C according to instructions from the content control device 2A. In the first embodiment, the first touch panel 311 and the first speaker 312 output a first content C1. The first touch panel 311 displays an image in the first content C1. The first speaker 312 outputs voice in the first content C1.

In the present embodiment, since the passenger PA is the driver, the first touch panel 311 is prohibited from displaying images when the passenger PA is driving.

The second output mechanism 32 is arranged on a dashboard in front of the second seat 12, for example. The second touch panel 321 of the second output mechanism 32 is arranged such that a display screen thereof faces the passenger PB seated on the second seat 12. In other words, the second touch panel 321 of the second output mechanism 32 is arranged such that the display screen faces rearward.

The second touch panel 321 and the second speaker 322 output the content C according to instructions from the content control device 2A. In the first embodiment, the second touch panel 321 and the second speaker 322 output the first content C1. The second touch panel 321 displays an image in the first content C1. The second speaker 322 outputs voice in the first content C1.

The third output mechanism 33 is arranged, for example, on a back surface of the first seat 11 in front of the third seat 13, that is, on the back surface of the backrest of the first seat 11. The third touch panel 331 of the third output mechanism 33 is arranged such that a display screen thereof faces the passenger PC. In other words, the third touch panel 331 of the third output mechanism 33 is arranged such that the display screen faces rearward.

The third touch panel 331 and the third speaker 332 output the content C according to instructions from the content control device 2A. In the first embodiment, the third touch panel 331 and the third speaker 332 output the first content C1. The third touch panel 331 displays an image in the first content C1. The third speaker 332 outputs voice in the first content C1.

The fourth output mechanism 34 is arranged, for example, on a back surface of the first seat 11 and the second seat 12 in front of the fourth seat 14. The fourth touch panel 341 of the fourth output mechanism 34 is arranged such that a display screen thereof faces the passenger P seated on the fourth seat 14. In other words, the fourth touch panel 341 of the fourth output mechanism 34 is arranged such that the display screen faces rearward.

The fourth touch panel 341 and the fourth speaker 342 output a content C according to instructions from the content control device 2A. The fourth touch panel 341 displays an image in the content C. The fourth speaker 342 outputs voice in the content C. In the present embodiment, since the passenger P is not seated on the fourth seat 14, the fourth touch panel 341 and the fourth speaker 342 do not output the content C.

The fifth output mechanism 35 is arranged, for example, on a back surface of the second seat 12 in front of the fifth seat 15. The fifth touch panel 351 of the fifth output mechanism 35 is arranged such that a display screen thereof faces the passenger PD. In other words, the fifth touch panel 351 of the fifth output mechanism 35 is arranged such that the display screen faces rearward.

The fifth touch panel 351 and the fifth speaker 352 output a content C according to instructions from the content control device 2A. In the first embodiment, the fifth touch panel 351 and the fifth speaker 352 output the first content C1. The fifth touch panel 351 displays an image in the first content C1. The fifth speaker 352 outputs voice in the first content C1.

The content control device 2A acquires the content C from a server device 5 (computer) illustrated in FIG. 2, and outputs the content C to the output mechanism 3.

In the first embodiment, the content control device 2A acquires the first content C1 from the first server device 51 illustrated in FIG. 2. The content control device 2A outputs the first content C1 to the first touch panel 311 and the first speaker 312 of the first output mechanism 31. The content control device 2A outputs the first content C1 to the second touch panel 321 and the second speaker 322 of the second output mechanism 32. The content control device 2A outputs the first content C1 to the third touch panel 331 and the third speaker 332 of the third output mechanism 33. The content control device 2A outputs the first content C1 to the fifth touch panel 351 and the fifth speaker 352 of the fifth output mechanism 35.

A configuration of the content control device 2A will be further described with reference to FIG. 2.

In the following description, the passenger PA, the passenger PB, the passenger PC, and the passenger PD may be referred to as the passenger P unless otherwise distinguished from one another.

In the present embodiment, a case will be described in which the passengers P are four person, that is, the passenger PA, the passenger PB, the passenger PC, and the passenger PD, but the embodiment is not limited thereto. For example, the passengers P may be three or less persons. Furthermore, for example, the passengers P may be five or more persons.

### 1-2. Configuration of Content Control Device

Next, the configuration of the content control device 2A will be described with reference to FIG. 2 according to the first embodiment. FIG. 2 is a diagram illustrating an example of the configuration of the content control device 2A according to the first embodiment.

As illustrated in FIG. 2, the content control device 2A is communicably connected to the first output mechanism 31, the second output mechanism 32, the third output mechanism 33, the fourth output mechanism 34, and the fifth output mechanism 35.

The first output mechanism 31 includes the first touch panel 311 and the first speaker 312.

The first touch panel 311 includes a display such as a liquid crystal display (LCD) and a touch sensor. The display displays various images according to instructions from the content control device 2A. The touch sensor is formed integrally with the display screen of the display, and detects a touch operation of the passenger P. The touch sensor outputs a signal indicating the detected touch operation to the content control device 2A.

The first speaker 312 outputs various types of voice according to instructions from the content control device 2A.

The second output mechanism 32 includes a second touch panel 321 and a second speaker 322. The third output mechanism 33 includes a third touch panel 331 and a third speaker 332. The fourth output mechanism 34 includes a fourth touch panel 341 and a fourth speaker 342. The fifth output mechanism 35 includes a fifth touch panel 351 and a fifth speaker 352.

Each of the second touch panel 321, the third touch panel 331, the fourth touch panel 341, and the fifth touch panel 351 has substantially the same configuration as the first touch panel 311.

In the following description, the first touch panel 311, the second touch panel 321, the third touch panel 331, the fourth touch panel 341, and the fifth touch panel 351 may be referred to as a “touch panel TP” unless otherwise distinguished from one another.

Each of the second speaker 322, the third speaker 332, the fourth speaker 342, and the fifth speaker 352 has substantially the same configuration as the first speaker 312.

In the following description, the first speaker 312, the second speaker 322, the third speaker 332, the fourth speaker 342, and the fifth speaker 352 may be referred to as a “speaker SP” unless otherwise distinguished from one another.

The content control device 2A is implemented by an electronic control unit (ECU), for example. The content control device 2A includes a processor 21, a memory 22, and a communication interface 23.

The communication interface 23 includes an antenna, a connector, and an interface circuit, and is connected to the processor 21. The communication interface 23 is an interface for communicating with the server device 5. The communication interface 23 is an interface for wirelessly communicating with the server device 5 according to the 4G standard, the 5G standard, or the Wi-Fi (registered trademark) standard.

The communication interface 23 wirelessly communicates with the server device 5 via a wireless base station (not illustrated) and the Internet.

The communication interface 23 constitutes a part of a “communication unit”.

The server device 5 includes, for example, a first server device 51.

The first server device 51 transmits the content C1 to the content control device 2A in response to a request from the content control device 2A.

The first content C1 is an example of the content C.

The first content C1 includes, for example, image information and voice information.

In the first embodiment, a case will be described in which the content C includes image information and voice information, but the embodiment is not limited thereto. The content C may be in a form that does not include image information but voice information, for example.

The processor 21 is implemented by a central processing unit (CPU) or a micro processor unit (MPU). The processor 21 may be implemented by a single processor or a plurality of processors. The memory 22 is implemented by, for example, a non-volatile semiconductor memory, or a combination of a volatile semiconductor memory and a non-volatile semiconductor memory. The memory 22 stores a control program PG.

The control program PG corresponds to an example of a “content control program”.

The content control device 2A includes a content acquisition unit 211, a content output unit 212, an output status acquisition unit 213, a communication state estimation unit 214, a notification unit 215, a content storage unit 221, a route storage unit 222, and a map storage unit 223.

The processor 21 executes the control program PG stored in the memory 22 to function as the content acquisition unit 211, the content output unit 212, the output status acquisition unit 213, the communication state estimation unit 214, and the notification unit 215. In addition, the processor 21 executes the control program PG stored in the memory 22 to cause the memory 22 to function as the content storage unit 221, the route storage unit 222, and the map storage unit 223.

The content storage unit 221 stores a content C acquired by the content acquisition unit 211. The content C is stored in the content storage unit 221 by the content acquisition unit 211.

The route storage unit 222 stores a route RT along which the vehicle 100 travels. The route RT is set, for example, by a route setting ECU (not illustrated), which is communicably connected to the content control device 2A, according to an instruction from the passenger PA. The route RT is acquired from the route setting ECU (not illustrated) by the content control device 2A, for example, and is stored in the route storage unit 222 by the content control device 2A.

The map storage unit 223 stores in advance communication map information MP that associates a communication state CS with position information. The communication state CS indicates a state of communication between the server device 5 and the communication interface 23. For example, when the vehicle 100 is located inside a tunnel, the communication state CS becomes poor. In addition, for example, when the vehicle 100 is located outside a service provision area of wireless communication executed by the communication interface 23, the communication state CS becomes poor. The communication map information MP is stored in the map storage unit 223 by a manufacturer of the vehicle 100, a sales company of the vehicle 100, or the like when the vehicle 100 is delivered, for example.

The content acquisition unit 211 is communicably connected to the first server device 51 via the communication interface 23, and acquires a first content C1 from the first server device 51. For example, based on instructions from the passenger P, the content acquisition unit 211 is communicably connected to the first server device 51 via the communication interface 23, and acquires the first content C1 from the first server device 51. The content acquisition unit 211 causes the content storage unit 221 to store the first content C1 acquired from the first server device 51.

The content acquisition unit 211 constitutes a part of the “communication unit”.

The first server device 51 corresponds to an example of the server device 5.

Here, an example of processing of the content acquisition unit 211 will be described.

First, the content acquisition unit 211 displays a plurality of icons on the touch panel TP, for example. The icons correspond to a website that provides the content C. The website corresponds to the first server device 51 that provides the content C. For example, the passenger P performs a touch operation to select one icon from the plurality of icons displayed on the touch panel TP. The content acquisition unit 211 is communicably connected to the first server device 51 corresponding to the selected one icon.

Next, the passenger P inputs account information via the touch panel TP. The content acquisition unit 211 transmits the account information to the first server device 51, which is communicably connected, and logs in to the first server device 51. The content acquisition unit 211 may transmit password information in addition to the account information.

Next, the content acquisition unit 211 displays icons corresponding to the plurality of contents C, which are provided by the first server device 51, on the touch panel TP. The passenger P performs a touch operation to select an icon corresponding to one content C, which is wished to view, from the plurality of contents C provided by the first server device 51. The content acquisition unit 211 downloads the selected one first content C1 from the first server device 51. Then, the content acquisition unit 211 causes the content storage unit 221 to store the first content C1 acquired from the first server device 51.

The content output unit 212 outputs the content C to the passenger P seated on the seat 1 of the vehicle 100. For example, the content output unit 212 outputs the first content C1 acquired by the content acquisition unit 211 to each of the first output mechanism 31, the second output mechanism 32, the third output mechanism 33, and the fifth output mechanism 35.

The output status acquisition unit 213 acquires an output status of the first content C1 being output by the content output unit 212.

For example, when the communication state estimation unit 214 estimates a poor communication state CN in which the communication interface 23 cannot acquire the content C, the output status acquisition unit 213 estimates a scheduled output period RP indicating a period until scheduled date and time when the output of the first content C1 will end. In other words, the scheduled output period RP indicates a period required to output the remaining part of the first content C1 that has not been output.

The output status acquisition unit 213 acquires, for example, a total output time AP indicating a period required to output all of the first content C1 and an already-output time EP indicating a period required to output the part that has been completely output, from the content output unit 212. Then, the output status acquisition unit 213 estimates, as the scheduled output period RP, a difference obtained by subtracting the already-output time EP from the total output time AP.

The communication state estimation unit 214 estimates a communication state CS of the communication interface 23. The communication state CS indicates, for example, a state of communication between the first server device 51 and the communication interface 23. The communication state CS includes, for example, a good communication state CG indicating that a communication state is good and a poor communication state CN indicating that the communication state is poor.

Furthermore, the communication state estimation unit 214 estimates a period of the poor communication state CN.

The communication state estimation unit 214 estimates the communication state CS of the communication interface 23 based on the route RT, the communication map information MP, for example. The communication state estimation unit 214 estimates a position of the vehicle 100 and the communication state CS of the communication interface 23 based on the route RT every unit time. The unit time is, for example, one minute.

The communication state estimation unit 214 estimates that the communication state CS is a poor communication state CN during a period when the vehicle 100 is estimated to be located inside a tunnel. In addition, the communication state estimation unit 214 estimates that the communication state CS is a poor communication state CN during a period when the vehicle 100 is estimated to be located outside a service provision area of wireless communication executed by the communication interface 23, for example.

In the good communication state CG, for example, the content acquisition unit 211 can acquire the content C from the first server device 51. In the poor communication state CN, for example, the content acquisition unit 211 cannot acquire the content C from the first server device 51.

The notification unit 215 notifies the passenger P of information related to the content C.

The notification unit 215 notifies the passenger P of different contents depending on the output status of the first content C1 acquired by the output status acquisition unit 213 and the communication state CS estimated by the communication state estimation unit 214.

The notification unit 215 changes the notification content depending on whether the scheduled output period RP overlaps the period in which the poor communication state CN is estimated. The scheduled output period RP indicates a period required to output the remaining part of the first content C1 that has not been output.

For example, when the scheduled output period RP does not overlap the period in which the poor communication state CN is estimated, the notification unit 215 notifies of the content including information related to the content C different from the content C1 being output. For example, the notification unit 215 notifies the passenger P that downloading the content C in advance is recommended.

For example, when the scheduled output period RP overlaps the period in which the poor communication state CN is estimated, the notification unit 215 notifies of the content including information related to the first content C1, which is the content C being output by the content output unit 212.

The notification unit 215 determines whether the scheduled output period RP ends within the period in which the poor communication state CN is estimated.

When the scheduled output period RP does not end within the period in which the poor communication state CN is estimated, the notification unit 215 notifies of the content including the first content C1, for example. In this case, the notification unit 215 notifies the passenger P of downloading of the first content C1.

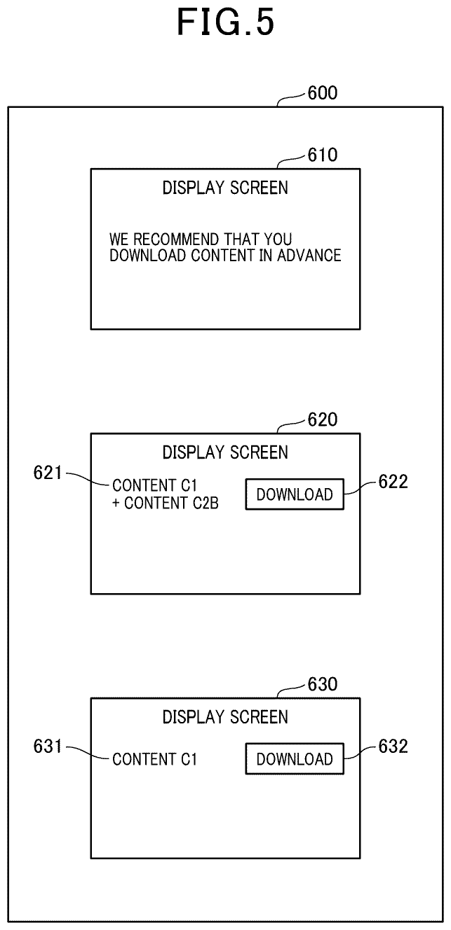

The notification content in this case will be described with reference to a display screen 630 in FIG. 5.

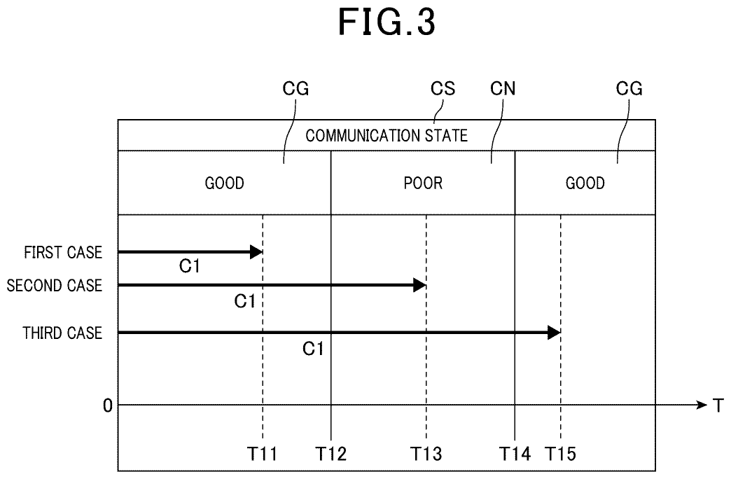

The above processing of the notification unit 215 will now be further described with reference to FIGS. 3 and 5.

FIG. 3 is a diagram illustrating a relation between the scheduled output period RP of the first content C1 and a poor communication period. The poor communication period is a period in which the poor communication state CN is estimated.

FIG. 5 is a diagram of a display screen 600 showing notification contents. The display screen 600 includes a display screen 610, a display screen 620, and a display screen 630.

A horizontal axis in FIG. 3 represents time T. That time T is “0” indicates, for example, a time when the communication state estimation unit 214 estimates the poor communication state CN.

A top of FIG. 3 shows the communication state CS estimated by the communication state estimation unit 214. The communication state CS includes a good communication state CG in which the communication state is good and a poor communication state CN in which the communication state is poor.

A period from time “0” to time T12 is a period in which the good communication state CG is estimated. A period from time T12 to time T14 is a period in which the poor communication state CN is estimated. A period after time T14 is a period in which the good communication state CG is estimated.

In addition, between the horizontal axis and the communication state CS, the scheduled output periods RP of the first content C1 are indicated by arrows corresponding to a first case, a second case, and a third case, respectively.

In the first case, the scheduled output period RP of the first content C1 ends at time T11, which is earlier than time T12. In other words, the first case corresponds to an example in which the scheduled output period RP does not overlap the period in which the poor communication state CN is estimated. In this case, the notification unit 215 notifies of the content including the information related to the content C different from the first content C1 being output. In this case, the notification unit 215 displays a message “We recommend that you download the content in advance” on the touch panel TP, as shown in the display screen 610 in FIG. 5, for example.

In the second case, the scheduled output period RP of the first content C1 ends at time T13, which is a period between time T12 and time T14 in which the poor communication state CN is estimated. In the third case, the scheduled output period RP of the first content C1 ends at time T15, which is later than time T14. Each of the second case and the third case corresponds to an example of a case in which the scheduled output period RP overlaps the period in which the poor communication state CN is estimated. In these cases, the notification unit 215 notifies of the content including the information related to the first content C1.

For example, in the third case, a content inquiring of the passenger P as to whether to download the first content C1 is displayed on the touch panel TP as shown on the display screen 630 in FIG. 5. When the passenger P touches a download button 632 shown on the display screen 630, the content acquisition unit 211 downloads the first content C1 from the first server device 51 and causes the content storage unit 221 to store it.

Returning to FIG. 2 again, the configuration of the content control device 2 will be further described.

The notification unit 215 determines whether the scheduled output period RP ends within the period in which the poor communication state CN is estimated.

In addition, when the scheduled output period RP ends within the period in which the poor communication state CN is estimated, the notification unit 215 notifies of a content including information related to the first content C1 and the second content C2, which is different from the first content C1 and is output after the end of the output of the first content C1 by the content output unit 212.

When the scheduled output period RP ends within the period in which the poor communication state CN is estimated, the notification unit 215 estimates the shortage period PS, which is a period in which the content C output by the content output unit 212 is short, based on the period in which the poor communication state CN is estimated and the scheduled output period RP. Then, the notification unit 215 notifies, as the second content C2, of the content C, which has an output period longer than the shortage period PS.

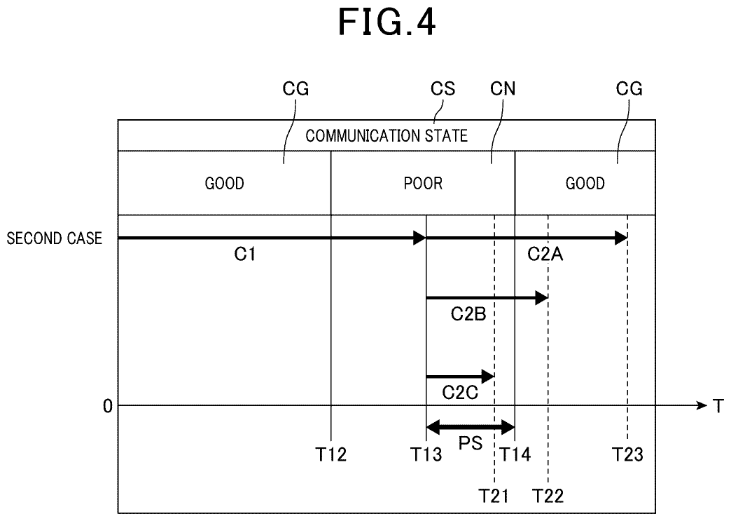

The above processing by the notification unit 215 will now be further described with reference to FIGS. 4 and 5.

FIG. 4 is a diagram illustrating a relation between the shortage period PS and the second content C2. The shortage period PS is a period in which there is a shortage of the content C output by the content output unit 212. In other words, the shortage period PS is a period in which the content storage unit 221 does not involve the content C output by the content output unit 212.

FIG. 5 is a diagram of the display screen 600 showing notification contents.

A horizontal axis in FIG. 4 represents time T. That time T is “0” indicates, for example, a time when the communication state estimation unit 214 estimates the poor communication state CN.

A top of FIG. 4 shows the communication state CS estimated by the communication state estimation unit 214. The communication state CS includes a good communication state CG in which the communication state is good and a poor communication state CN in which the communication state is poor.

A period from time “0” to time T12 is a period in which the good communication state CG is estimated. A period from time T12 to time T14 is a period in which the poor communication state CN is estimated. A period after time T14 is a period in which the good communication state CG is estimated.

In addition, between the horizontal axis and the communication state CS, the scheduled output period RP of the first content C1 is indicated by an arrow corresponding to a second case. The second case corresponds to the second case illustrated in FIG. 3.

In the second case, the scheduled output period RP of the first content C1 ends at time T13, which is a period between time T12 and time T14 during the poor communication state CN is estimated. In this case, the shortage period PS is a period from time T13 to time T14.

Each of a content C2A, a content C2B, and a content C2C indicates an example of a candidate for a second content C2. The second content C2 is a content C that is output by the content output unit 212 after the output of the first content C1 is completed. Three right-directed arrows starting from time T13 indicate periods during the content C2A, the content C2B, and the content C2C are output, respectively.

For example, when the second content C2 is the content C2A, the period during the content output unit 212 outputs the content C2A is a period from time T13 to time T23. Time T23 is a time later than time T14 when the poor communication state CN ends. In other words, the content C2A corresponds to an example of the content C whose output period is longer than the shortage period PS.

For example, when the second content C2 is the content C2B, the period during the content output unit 212 outputs the content C2B is a period from time T13 to time T22. Time T22 is a time later than time T14 when the poor communication state CN ends. In other words, the content C2B corresponds to an example of the content C whose output period is longer than the shortage period PS. Time T22 is located between time T14 and time T23. In other words, the content C2B has an output period shorter than the content C2A.

For example, when the second content C2 is the content C2C, the period during the content output unit 212 outputs the content C2C is a period from time T13 to time T21. Time T21 is a time earlier than time T14 when the poor communication state CN ends. In other words, the content C2C corresponds to an example of the content C having an output period shorter than the shortage period PS.

As described with reference to FIG. 4, when the candidates for the second content C2 include the content C2A, the content C2B, and the content C2C, the notification unit 215 notifies, as the second content C2, of the content C2A or the content C2B which has the output period longer than the shortage period PS.

For example, as shown on the display screen 620 in FIG. 5, a content inquiring of the passenger P as to whether to download the first content C1 and the second content C2B is displayed on the touch panel TP. When the passenger P touches a download button 622 shown on the display screen 620, the content acquisition unit 211 downloads the first content C1 and the second content C2B from the server device 5 and causes the content storage unit 221 to store them.

In this case, the content acquisition unit 211 downloads the first content C1 and the second content C2B from the server device 5 in the good communication state CG until time T12, and causes the content storage unit 221 to store them. Therefore, during the period in which the poor communication state CN is estimated, that is, the period from time T12 to time T14, the content output unit 212 can output the first content C1 and the second content C2B. Whereby, the convenience for the passenger P can be improved.

### 1-3. Processing of Content Control Device

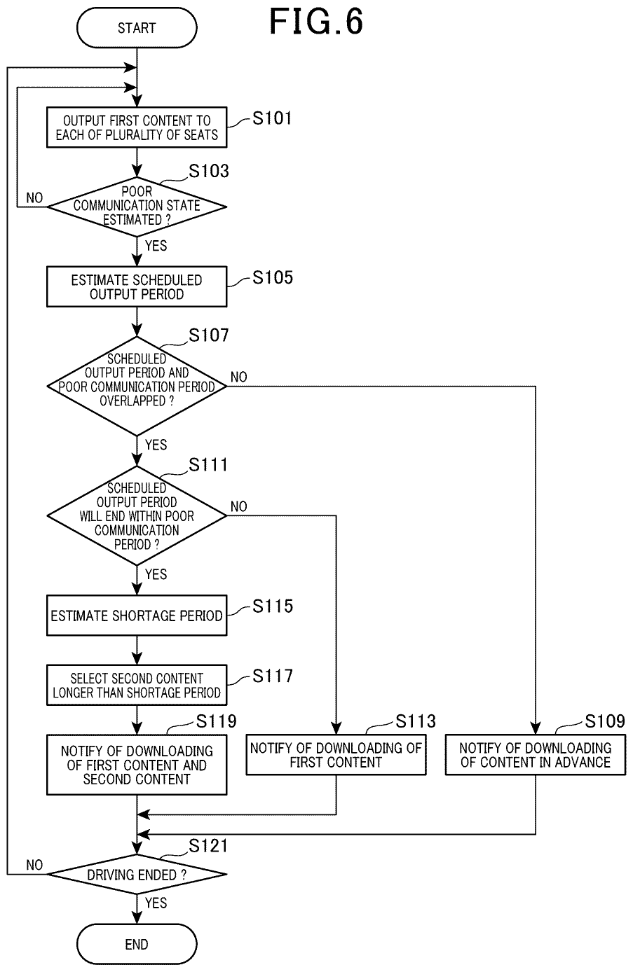

Next, the processing of the content control device 2 will be described with reference to FIG. 6. FIG. 6 is a flowchart illustrating an example of the processing of the content control device 2.

First, in step S101, the content acquisition unit 211 downloads the first content C1 from the first server device 51 based on an instruction from the passenger P, and the content output unit 212 outputs the first content C1 from the output mechanism 3 corresponding to each of the plurality of seats 1.

Next, in step S103, the communication state estimation unit 214 determines whether the poor communication state CN is estimated as the communication state CS. The poor communication state CN indicates a state in which the communication between the first server device 51 and the communication interface 23 is poor. In other words, the poor communication state CN indicates the communication state CS in which the content acquisition unit 211 cannot acquire the content C from the first server device 51.

When the communication state estimation unit 214 determines that the poor communication state CN is not estimated (step S103; NO), the process returns to step S101. When the communication state estimation unit 214 determines that the poor communication state CN is estimated (step S103; YES), the process proceeds to step S105.

Next, in step S105, the output status acquisition unit 213 estimates the scheduled output period RP. The scheduled output period RP indicates the period required to output the remaining part of the first content C1 that has not been output.

Next, in step S107, the notification unit 215 determines whether the scheduled output period RP overlaps the period in which the poor communication state CN is estimated. In FIG. 6, for convenience, the period in which the poor communication state CN is estimated is referred to as the “poor communication period”.

When the notification unit 215 determines that the scheduled output period RP does not overlap the period in which the poor communication state CN is estimated (step S107; NO), the process proceeds to step S109.

Then, in step S109, the notification unit 215 notifies of the content including the information related to the content C different from the first content C1 being output. For example, the notification unit 215 notifies the passenger P that downloading the content C different from the first content C1 being output in advance is recommended. The notification unit 215 displays, for example, the display screen 610 illustrated in FIG. 5 on the touch panel TP. Thereafter, the process proceeds to step S121.

When the notification unit 215 determines that the scheduled output period RP overlaps the period in which the poor communication state CN is estimated (step S107; YES), the process proceeds to step S111.

Then, in step S111, the notification unit 215 determines whether the scheduled output period RP ends within the period in which the poor communication state CN is estimated.

When the notification unit 215 determines that the scheduled output period RP does not end within the period in which the poor communication state CN is estimated (step S111; NO), the process proceeds to step S113.

Then, in step S113, the notification unit 215 notifies the passenger P to download the first content C1. The notification unit 215 displays, for example, the display screen 630 illustrated in FIG. 5 on the touch panel TP. Thereafter, the process proceeds to step S121.

When the notification unit 215 determines that the scheduled output period RP ends within the period in which the poor communication state CN is estimated (step S111; YES), the process proceeds to step S115.

Then, in step S115, the notification unit 215 estimates the shortage period PS, which is a period in which the content C output by the content output unit 212 is short, based on the period in which the poor communication state CN is estimated and the scheduled output period RP.

Next, in step S117, the notification unit 215 selects, as the second content C2, the content C which has the output period longer than the shortage period PS.

Next, in step S119, the notification unit 215 notifies the passenger P to download the first content C1 and the second content C. The notification unit 215 displays, for example, the display screen 620 illustrated in FIG. 5 on the touch panel TP.

Next, in step S121, the content control device 2A determines whether driving of the vehicle 100 is ended.

When the content control device 2A determines that the driving of the vehicle 100 is not ended (step S121; NO), the process returns to step S101. When the content control device 2A determines that the driving of the vehicle 100 is ended (step S121; YES), the process then ends.

Steps S109, S113, and S119 correspond to an example of a “notification step”.

### 1-4. Configurations and Effects

As described above with reference to FIGS. 1 to 5, the content control device 2A according to the first embodiment includes: the content output unit 212 that outputs the content C to the passenger P seated on the seat 1 of the vehicle 100; the output status acquisition unit 213 that acquires the output status of the first content C1 being output by the content output unit 212; the content acquisition unit 211 that communicates with the external device of the vehicle 100 via the communication interface 23 to acquire a first content C1; the communication state estimation unit 214 that estimates the communication state CS of the communication interface 23; the content storage unit 221 that stores the first content C1 acquired by the content acquisition unit 211; and the notification unit 215 that notifies the passenger P of the information related to the content C, and the notification unit 215 varies the notification content depending on the output status of the first content C1 acquired by the output status acquisition unit 213 and the communication state CS estimated by the communication state estimation unit 214.

According to such a configuration, since the notification content varies depending on the output status of the first content C1 and the communication state CS, it is possible to notify the passenger P of the vehicle 100 of appropriate content information. For example, depending on the output status of the first content C1 and the communication state CS, the display screen 610, the display screen 620, or the display screen 630 illustrated in FIG. 5 is displayed on the touch panel TP. Therefore, for example, when the poor communication state CN occurs, it is possible to notify the passenger P of the vehicle 100 of appropriate content information.

In the content control device 2A, when the communication state estimation unit 214 estimates the poor communication state CN in which the content acquisition unit 211 is not capable of acquiring the content C, the output status acquisition unit 213 estimates the scheduled output period RP indicating the period until the scheduled date and time when the output of the first content C1 ends, and the notification unit 215 varies the notification content depending on whether the scheduled output period RP overlaps the period in which the poor communication state CN is estimated.

According to such a configuration, when the poor communication state CN is estimated in which the content acquisition unit 211 is not capable of acquiring the content C, the notification content varies depending on whether the scheduled output period RP overlaps the period in which the poor communication state CN is estimated, the scheduled output period RP indicating the period until the scheduled date and time when the output of the acquired first content C1 ends. When the scheduled output period RP does not overlap the period in which the poor communication state CN is estimated, for example, the display screen 610 illustrated in FIG. 5 is displayed on the touch panel TP. In addition, when the scheduled output period RP overlaps the period in which the poor communication state CN is estimated, the display screen 620 or the display screen 630 illustrated in FIG. 5 is displayed on the touch panel TP. Therefore, when the poor communication state CN occurs, it is possible to notify the passenger P of the vehicle 100 of appropriate content information.

In the content control device 2A, when the scheduled output period RP overlaps the period in which the poor communication state CN is estimated by the communication state estimation unit 214, the notification unit 215 notifies of the content including the information related to the first content C1, which is the content C being output by the content output unit 212.

According to such a configuration, when the scheduled output period RP overlaps the period in which the poor communication state CN is estimated by the communication state estimation unit 214, the notification unit 215 displays, as the notification content including the information related to the first content C1, the display screen 620 or the display screen 630 illustrated in FIG. 5 on the touch panel TP. Therefore, the passenger P can know that is necessary to download the first content C1. Thus, when the poor communication state CN occurs, it is possible to notify the passenger P of the vehicle 100 of appropriate content information.

In the content control device 2A, when the scheduled output period RP ends within the period in which the poor communication state CN is estimated, the notification unit 215 notifies of the content including the information related to the first content C1 and the second content C2, which is different from the first content C1 and is output after the end of the output of the first content C1 by the content output unit 212.

According to such a configuration, when the scheduled output period RP ends within the period in which the poor communication state CN is estimated, the notification unit 215 displays, as the notification content including the information related to the first content C1 and the second content C2, the display screen 620 illustrated in FIG. 5 on the touch panel TP. Therefore, the passenger P can know that it is necessary to download the first content C1 and the second content C2. Thus, when the poor communication state CN occurs, it is possible to notify the passenger P of the vehicle 100 of appropriate content information.

In the content control device 2A, when the scheduled output period RP ends within the period in which the poor communication state CN is estimated, the notification unit 215 estimates the shortage period PS, which is the period in which the content C output by the content output unit 212 is short, based on the period in which the poor communication state CN is estimated and the scheduled output period RP, and notifies, as the second content C2, of the content C which has the output period longer than the shortage period PS.

According to such a configuration, when the scheduled output period RP ends within the period in which the poor communication state CN is estimated, the shortage period PS is estimated based on the period in which the poor communication state CN is estimated and the scheduled output period RP, and the content C having the output period longer than the shortage period PS is notified as the second content C2. For example, the second content C2A or the second content C2B illustrated in FIG. 4 is notified as the second content C2. For example, as illustrated in FIG. 5, the display screen 620 is displayed on the touch panel TP to urge to download the first content C1 and the second content C2B. Therefore, the passenger P can know that it is necessary to download the first content C1 and the second content C2B, which has the output period longer than the shortage period PS. Thus, when the poor communication state CN occurs, it is possible to notify the passenger P of the vehicle 100 of appropriate content information.

A content control method according to the first embodiment is performed by the content control device 2A including: the content output unit 212 that outputs the first content C1 to the passenger P seated on the seat 1 of the vehicle 100; the output status acquisition unit 213 that acquires the output status of the first content C1 being output by the content output unit 212; the content acquisition unit 211 that communicates with the external device of the vehicle 100 via the communication interface 23 to acquire a first content C1; the communication state estimation unit 214 that estimates the communication state CS of the communication interface 23; the content storage unit 221 that stores the first content C1 acquired by the content acquisition unit 211; and the notification unit 215 that notifies the passenger P of the information related to the content C, and the notification unit 215 executes a notification step of varying the notification content depending on the output status of the first content C1 acquired by the output status acquisition unit 213 and the communication state CS estimated by the communication state estimation unit 214.

Therefore, the content control method according to the first embodiment has the same operational effects as the content control device 2A according to the first embodiment.

A control program PG according to the first embodiment causes a processor provided in a content control device arranged in a vehicle to function as: the content output unit 212 that outputs the first content C1 to the passenger P seated on the seat 1 of the vehicle 100; the output status acquisition unit 213 that acquires the output status of the first content C1 being output by the content output unit 212; the content acquisition unit 211 that communicates with the external device of the vehicle 100 via the communication interface 23 to acquire a first content C1; the communication state estimation unit 214 that estimates the communication state CS of the communication interface 23; the content storage unit 221 that stores the first content C1 acquired by the content acquisition unit 211; and the notification unit 215 that notifies the passenger P of the information related to the content C, and the notification unit 215 varies the notification content depending on the output status of the first content C1 acquired by the output status acquisition unit 213 and the communication state CS estimated by the communication state estimation unit 214.

Therefore, the control program PG according to the first embodiment has the same operational effects as the content control device 2A according to the first embodiment.

### SECOND EMBODIMENT

### 2-1. Configuration of Vehicle

First, a configuration of a vehicle 100 mounted with a content control device 2B according to a second embodiment will be described with reference to FIG. 7. FIG. 7 is a plan view illustrating an example of the vehicle 100 mounted with the content control device 2B according to the second embodiment.

The vehicle 100 includes a seat 1, a content control device 2B, and an output mechanism 3. The seat 1 has the same configuration as the seat 1 described with reference to FIG. 1. The output mechanism 3 has the same configuration as the output mechanism 3 described with reference to FIG. 1.

In the following description, differences between the content control device 2B and the content control device 2A described with reference to FIG. 1 will be mainly described, and the same configuration as the content control device 2A will not be described.

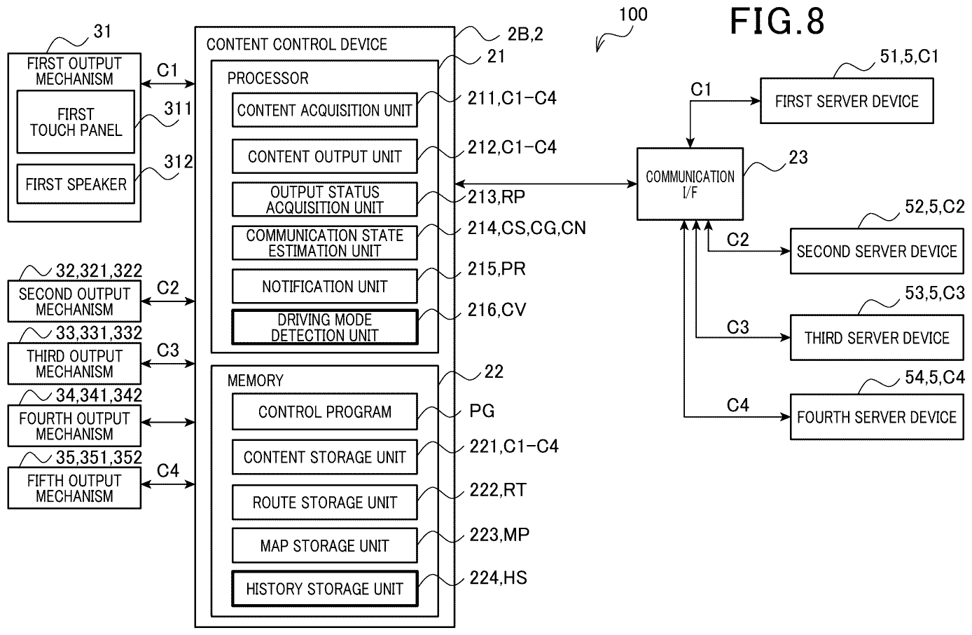

In the second embodiment, the content control device 2B acquires a content C1 from a first server device 51 illustrated in FIG. 8. In addition, the content control device 2B outputs the content C1 to a first touch panel 311 and a first speaker 312 of a first output mechanism 31.

The content control device 2B acquires a content C2 from a second server device 52 illustrated in FIG. 8. In addition, the content control device 2B outputs the content C2 to a second touch panel 321 and a second speaker 322 of the second output mechanism 32.

The content control device 2B acquires a content C3 from a third server device 53 illustrated in FIG. 8. In addition, the content control device 2B outputs the content C3 to a third touch panel 331 and a third speaker 332 of the third output mechanism 33.

The content control device 2B acquires a content C4 from a fourth server device 54 illustrated in FIG. 8. In addition, the content control device 2B outputs the content C4 to a fifth touch panel 351 and a fifth speaker 352 of the fifth output mechanism 35.

The content C1, the content C2, the content C3, and the content C4 are, for example, contents C that are different from each other.

The content C1, the content C2, the content C3, and the content C4 correspond to an example of a “plurality of contents”.

The first server device 51, the second server device 52, the third server device 53, and the fourth server device 54 have substantially the same configuration. Each of the first server device 51, the second server device 52, the third server device 53, and the fourth server device 54 may be referred to as a server device 5 in the following description unless otherwise distinguished from one another.

In the second embodiment, a case will be described in which the content control device 2B acquires four contents C, that is, the content C1, the content C2, the content C3, and the content C4, but the content control device 2B according to the second embodiment is not limited thereto. The content control device 2B may acquire a plurality of contents C. The content control device 2B may acquire, for example, two contents C. For example, the content control device 2B may acquire three contents C, for example. For example, the content control device 2B may acquire five or more contents C, for example.

### 2-2. Configuration of Content Control Device

Next, the configuration of the content control device 2B according to the second embodiment will be described with reference to FIG. 8. FIG. 8 is a diagram illustrating an example of the configuration of the content control device 2B according to the second embodiment.

In the following description, differences between the content control device 2B and the content control device 2A described with reference to FIG. 2 will be mainly described, and the same configuration as the content control device 2A will not be described by assigning the same reference numeral.

The content control device 2B is implemented by, for example, an ECU. The content control device 2B includes a processor 21, a memory 22, and a communication interface 23.

The content control device 2B includes a content acquisition unit 211, a content output unit 212, an output status acquisition unit 213, a communication state estimation unit 214, a notification unit 215, a driving mode detection unit 216, content storage unit 221, a route storage unit 222, a map storage unit 223, and a history storage unit 224.

The processor 21 executes a control program PG stored in the memory 22 to function as the content acquisition unit 211, the content output unit 212, the output status acquisition unit 213, the communication state estimation unit 214, the notification unit 215, and the driving mode detection unit 216. In addition, the processor 21 executes the control program PG stored in the memory 22 to cause the memory 22 to function as the content storage unit 221, the route storage unit 222, the map storage unit 223, and the history storage unit 224.

In other words, the content control device 2B differs from the content control device 2A illustrated in FIG. 2 in terms of including the driving mode detection unit 216 and the history storage unit 224.

The content storage unit 221 stores contents C1 to C4 acquired by the content acquisition unit 211. The contents C1 to C4 are stored in the content storage unit 221 by the content acquisition unit 211.

The history storage unit 224 stores output histories HS of contents C of a plurality of passengers P seated on the seats 1 of the vehicle 100.

As illustrated in FIG. 7, in the second embodiment, the plurality of passengers P seated on the seats 1 of the vehicle 100 include a passenger PA seated on the seat 11, a passenger PB seated on the seat 12, a passenger PC seated on the seat 13, and a passenger PD seated on the seat 15. In this case, the history storage unit 224 stores an output history HS of the content C of each of the passengers PA to PD.

The history storage unit 224 stores, as the output history HS of the content C, a type of content C with the longest output time or the largest number of occurrences of output, based on the past output history of the content C, for example. The “type of content C” includes, for example, a video content CP, a music content CM, and a radio content CR.

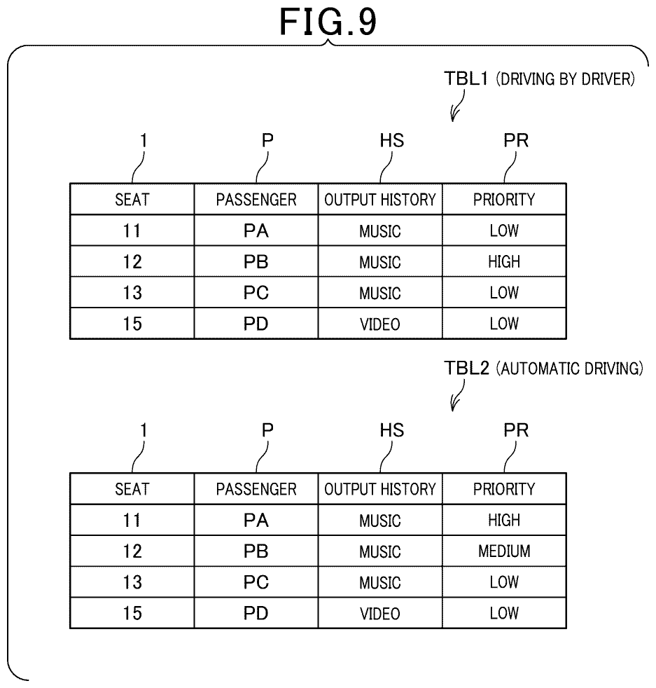

The output history HS will be further described with reference to FIG. 9.

The content acquisition unit 211 is communicably connected to the server device 5 via the communication interface 23, and acquires contents C1 to C4 from the server device 5. For example, based on instructions from the passenger P, the content acquisition unit 211 is communicably connected to the server device 5 via the communication interface 23, and acquires the contents C1 to C4 from the server device 5. The content acquisition unit 211 causes the content storage unit 221 to store the contents C1 to C4 acquired from the server device 5.

The content output unit 212 outputs the contents C1 to C4 to the passenger P seated on the seat 1 of the vehicle 100. The content output unit 212 outputs, for example, the first contents C1 to C4 acquired by the content acquisition unit 211 to each of the first output mechanism 31, the second output mechanism 32, the third output mechanism 33, and the fifth output mechanism 35.

The output status acquisition unit 213 acquires an output status of the contents C1 to C4 being output by the content output unit 212.

When the communication state estimation unit 214 estimates a poor communication state CN in which the communication interface 23 cannot acquire the content C, the output status acquisition unit 213 estimates a scheduled output period RP indicating a period until scheduled date and time when the output of each of the contents C1 to C4 will end. In other words, the scheduled output period RP indicates a period required to output the remaining part of the contents C1 to C4 that have not been output.

The output status acquisition unit 213 acquires, for example, a total output time AP indicating a period required to output all of the contents C1 to C4 and an already-output time EP indicating a period required to output the part that has been completely output, from the content output unit 212. Then, the output status acquisition unit 213 estimates, as the scheduled output period RP, a difference obtained by subtracting the already-output time EP from the total output time AP.

The communication state estimation unit 214 estimates a communication state CS of the communication interface 23. The communication state CS indicates, for example, a state of communication between the server device 5 and the communication interface 23. The communication state CS includes, for example, a good communication state CG indicating that a communication state is good and a poor communication state CN indicating that the communication state is poor.

Furthermore, the communication state estimation unit 214 estimates a period of the poor communication state CN.

The driving mode detection unit 216 communicates with an ECU (not illustrated) that controls a driving mode CV of the vehicle 100, and acquires the driving mode CV from the ECU (not illustrated), thereby acquiring the driving mode CV of the vehicle 100. The driving mode CV of the vehicle 100 indicates, for example, whether the vehicle 100 is being driven by a driver or is being in automatic driving.

In the second embodiment, the “automatic driving” means so-called automatic driving of “level 3” or higher as defined by society of automotive engineers (SAE).

The driving mode CV will be further described with reference to FIG. 9.

The notification unit 215 notifies the passenger P of information related to the content C.

The notification unit 215 changes the notification content to be notified to the passenger P depending on the output status of the contents C1 to C4 acquired by the output status acquisition unit 213 and the communication state CS estimated by the communication state estimation unit 214.

When there are a plurality of contents C for which the scheduled output period RP overlaps the period in which the poor communication state CN is estimated, from among the contents C1 to C4, the notification unit 215 sets a priority PR for each of the plurality of contents C and determines the notification content according to the priority PR.

For example, the notification unit 215 includes, in the notification content, information related to the content C with the priority PR equal to or more than a predetermined priority from among the plurality of contents C. For example, when the priority PR is set to three levels of “high”, “medium”, and “low”, the predetermined priority is, for example, “medium”.

The information related to the content C involves, for example, guidance information that urges to download the content C being output.

When there are a plurality of contents C for which the scheduled output period RP overlaps the period in which the poor communication state CN is estimated, from among the contents C1 to C4, the notification unit 215 sets a higher priority PR for the content as the number of passengers P to whom the content is output is larger, from among the plurality of contents C, and determines the notification content according to the priority PR.

The “number of passengers P to whom the content is output” is determined, for example, as follows.

For example, when the content C1 and the content C2 are the same content C, the number of passengers P to whom the content C1 and the content C2 are output is two. Furthermore, when the content C1, the content C3, and the content C4 are different from one another, the number of passengers P to whom the content C3 and the content C4 are output is one.

In this case, the notification unit 215 sets the priority PR for the content C1 from among the contents C1 to C4 to be higher than the priority PR for the content C3 and the content C4. For example, the notification unit 215 sets the priority PR for the content C1 to be “high”, and sets the priority PR for the content C3 and the content C4 to be “low”.

In this way, the larger the number of passengers P to whom the content is output is, the higher the priority PR for the content is set, from among the plurality of contents C, whereby the priority PR can be appropriately set, the notification content can be determined according to the appropriately set priority PR, and thus it is possible to notify the passenger P of the vehicle 100 of appropriate content information.

When there are a plurality of contents C for which the scheduled output period RP overlaps the period in which the poor communication state CN is estimated, from among the contents C1 to C4, the notification unit 215 classifies each of the plurality of contents C into types of content C, and the notification unit 215 sets a higher priority PR for a type of content C as the number of passengers P to whom the content is output is larger, from among the types of content C to determine the notification content according to the priority PR.

The “type of content C” includes, for example, a video content CP, a music content CM, and a radio content CR.

In this case, the “number of passengers P to whom the content is output” is determined, for example, as follows.

For example, when the content C1 and the content C2 are a music content CM, the content C3 is a video content CP, and the content C4 is a radio content CR, the number of passengers P to whom the type of the content C is output is determined as follows. In other words, the number of passengers P to whom the music content CM, which is a type of a content C of the content C1 and the content C2, is output is two, the number of passengers P to whom the video content CP, which is a type of the content C3, is output is one, and the number of passengers P to whom the radio content CR, which is a type of the content C4, is output is one.

In this case, the notification unit 215 sets the priority PR for the content C1 and the content C2 from among the contents C1 to C4 to be higher than the priority PR for the content C3 and the content C4. For example, the notification unit 215 sets the priority PR for the content C1 to be “high”, and sets the priority PR for the content C3 and the content C4 to be “low”.

In this way, each of the plurality of contents C is classified into types of content C, and the larger the number of passengers P to whom the content is output is, the higher the priority PR for the type of content C is set, from among the types of content C, whereby the priority PR can be appropriately set. In addition, the notification content is determined according to the priority PR set appropriately, and thus it is possible to notify the passenger P of the vehicle 100 of appropriate content information.

In a case where the scheduled output period RP of any of the plurality of contents C does not overlap the period in which the poor communication state CN is estimated by the communication state estimation unit 214, the notification unit 215 determines the notification content as follows. In other words, the notification unit 215 notifies of the content including the information related to the content C different from the content C being output.

The notification unit 215 determines, based on the output history HS of the content C of the corresponding passenger P, the content C different from the content C being output.

The case where the scheduled output period RP does not overlap the period in which the poor communication state CN is estimated by the communication state estimation unit 214 is a case where the output of the content C being output is completed before the period in which the poor communication state CN is estimated begins, as described with reference to FIG. 3 for the content control device 2A according to the first embodiment.

In addition, the “content C different from the content C being output” is, for example, a content C to be output after the output of the content C being output is completed.

In this way, when the scheduled output period RP does not overlap the period in which the poor communication state CN is estimated by the communication state estimation unit 214, the content C different from the content C being output is determined based on the output history HS of the content C of the corresponding passenger P, and thus it is possible to appropriately determine the content C to be output after the output of the content C being output is completed. In other words, it is possible to appropriately determine the content C that suits the taste of the passenger P.

When the scheduled output period RP of any of the plurality of contents C does not overlap the period in which the poor communication state CN is estimated by the communication state estimation unit 214, the notification unit 215 sets a priority PR according to the seat 1 on which each of the plurality of passengers P is seated. In addition, the notification unit 215 determines whether to include the content C different from the content C being output in the notification content according to the priority PR.

When the scheduled output period RP of any of the plurality of contents C does not overlap the period in which the poor communication state CN is estimated by the communication state estimation unit 214, the notification unit 215 performs the following processing based on the driving mode CV detected by the driving mode detection unit 216.

In other words, when the driving mode CV indicates driving by a driver, the notification unit 215 sets, for example, the priority PR for the seat 1 other than the seat 11 to be higher than that of the seat 11. Furthermore, when the driving mode CV indicates automatic driving, the notification unit 215 sets, for example, the priority PR for the seat 11 to be higher than the priority PR for the seat 1 other than the seat 11.

Next, a case will be described with reference to FIG. 9 in which the notification unit 215 sets the priority PR according to the seat 1 on which each of the plurality of passengers P is seated when the scheduled output period RP does not overlap the period in which the poor communication state CN is estimated by the communication state estimation unit 214. FIG. 9 is a diagram illustrating a relation between the seat 11 and the priority PR. In FIG. 9, a description is made with respect to a case in which the priority PR is set to three levels, for example, “high”, “medium”, and “low”.

A first table TBL1 in FIG. 9 shows an example of the seat 1, the passenger P, the output history HS, and the priority PR when the driving mode CV indicates driving by a driver.

As shown in the first table TBL1, the notification unit 215 sets the priority PR for the seat 1 other than the first seat 11, which is the driver's seat, to be higher than that of the first seat 11. The seat 1 other than first seat 11 is, for example, a second seat 12. For example, the notification unit 215 sets the priority PR for the first seat 11, which is the driver's seat, to be “low”, sets the priority PR for the second seat 12 to be “high”, and sets the priority PR for the third seat 13 and the fifth seat 15 to be “low”.

In this case, the notification unit 215 determines the content C different from the content C being output to be included in the notification content, based on the output history HS of the passenger PB on the seat 12 for which the priority PR is set to be “high”, for example.

As shown in the first table TBL1, the output history HS of the passenger PB on the seat 12, for which the priority PR is set to be “high”, is a music content CM. Therefore, the notification unit 215 determines, as the music content CM, the content C different from the content C being output to be included in the notification content. In other words, the notification unit 215 notifies the passenger P of the music content CM.

A second table TBL2 in FIG. 9 shows an example of the seat 1, the passenger P, the output history HS, and the priority PR when the driving mode CV indicates automatic driving.

As shown in the second table TBL2, the notification unit 215 sets the priority PR for the first seat 11, which is the driver's seat, to be higher than the priority PR for the seat 1 other than the first seat 11, for example. The seat 1 other than first seat 11 is, for example, a second seat 12. For example, the notification unit 215 sets the priority PR for the first seat 11, which is the driver's seat, to be “high”, sets the priority PR for the second seat 12 to be “medium”, and sets the priority PR for the third seat 13 and the fifth seat 15 to be “low”.

In this case, the notification unit 215 determines the content C different from the content C being output to be included in the notification content, based on the output history HS of the passenger PA on the first seat 11 for which the priority PR is set to be “high”, for example.

As shown in the second table TBL2, the output history HS of the passenger PA on the first seat 11, for which the priority PR is set to be “high”, is a music content CM. Therefore, the notification unit 215 determines, as the music content CM, the content C different from the content C being output to be included in the notification content. In other words, the notification unit 215 notifies the passenger P of the music content CM.

As described above, the notification unit 215 sets, for example, the priority PR for the seat 1 other than the first seat 11 to be higher than that of the first seat 11 when the driving mode CV indicates the driving by the driver. In addition, the notification unit 215 sets, for example, the priority PR for the first seat 11 to be higher than the priority PR for the seat 1 other than the first seat 11 when the driving mode CV indicates the automatic driving. Therefore, the priority PR can be appropriately set. In addition, it is possible to determine the content C different from the content C being output to be included in the notification content, based on the output history HS of the passenger P with the priority PR. Therefore, it is possible to appropriately determine the content C different from the content C being output.

### 2-3. Processing of Content Control Device

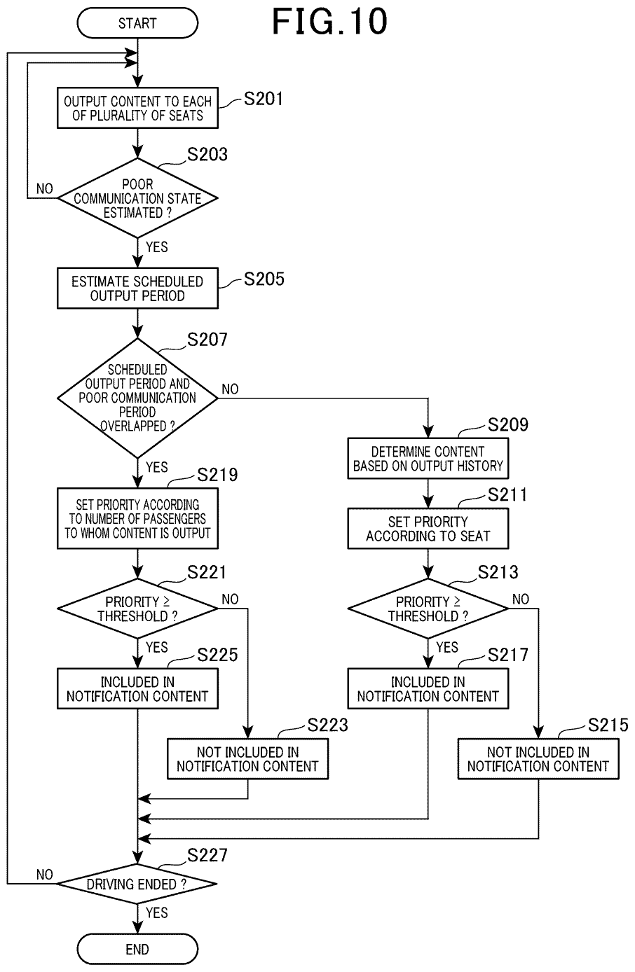

Processing of the content control device 2B according to the second embodiment will be described with reference to FIG. 10. FIG. 10 is a flowchart illustrating an example of the processing of the content control device 2B according to the second embodiment.

First, in step S201, the content acquisition unit 211 downloads the contents C1 to C4 from the server device 5 based on an instruction from the passenger P, and the content output unit 212 outputs the contents C1 to C4 from the output mechanism 3 corresponding to each of the plurality of seats 1.

Next, in step S203, the communication state estimation unit 214 determines whether the poor communication state CN is estimated as the communication state CS. The poor communication state CN indicates a state in which the communication between the server device 5 and the communication interface 23 is poor. In other words, the poor communication state CN indicates the communication state CS in which the content acquisition unit 211 cannot acquire the content C from the server device 5.

When the communication state estimation unit 214 determines that the poor communication state CN is not estimated (step S203; NO), the process returns to step S201. When the communication state estimation unit 214 determines that the poor communication state CN is estimated (step S203; YES), the process proceeds to step S205.

Next, in step S205, the output status acquisition unit 213 estimates the scheduled output period RP. The scheduled output period RP indicates the period required to output the remaining part of the contents C1 to C4 that has not been output.

Next, in step S207, the notification unit 215 determines whether the scheduled output period RP for each of the contents C1 to C4 overlaps the period in which the poor communication state CN is estimated. In FIG. 10, for convenience, the period in which the poor communication state CN is estimated is referred to as the “poor communication period”.

When the notification unit 215 determines that the scheduled output period RP overlaps the period in which the poor communication state CN is estimated (step S207; YES), the process proceeds to step S219. When the notification unit 215 determines whether the scheduled output period RP does not overlap the period in which the poor communication state CN is estimated (step S207; NO), the process proceeds to step S209.

For convenience, in a case of No in step S207, a case will be described in which the notification unit 215 determines that the scheduled output period RP for each of the contents C1 to C4 does not overlap the period in which the poor communication state CN is estimated.

Then, in step S209, the notification unit 215 determines, based on the output history HS of the passenger P corresponding to each of the contents C1 to C4, the content C different from the contents C1 to C4 being output. The content C different from the contents C1 to C4 being output indicates the content C that is output by the content output unit 212 after the output of each of the contents C1 to C4 is completed.

Next, in S211, the notification unit 215 sets the priority PR according to the seat 1 on which each of the plurality of passengers P is seated. The priority PR is set to three levels, for example, “high”, “medium”, and “low”.

Next, in step S213, the notification unit 215 determines whether the priority PR is equal to or more than a threshold. The threshold indicates that the priority PR is “medium”, for example.

When the notification unit 215 determines whether the priority PR is not equal to or more than a threshold (step S213; NO), the process proceeds to step S215.

Then, in step S215, the notification unit 215 determines, for the seat 1 that is determined not to be equal to or more than the threshold in the priority PR, that the notification content does not include the content C different from the contents C1 to C4 being output as determined in step S209, the process proceeds to step S227.

When the notification unit 215 determines that the priority PR is equal to or more than the threshold (step S213; YES), the process proceeds to step S217.

Then, in step S217, the notification unit 215 determines, for the seat 1 that is determined to be equal to or more than the threshold in the priority PR, that the notification content includes the content C different from the contents C1 to C4 being output as determined in step S209, the process proceeds to step S227. In step S217, for example, the notification unit 215 notifies the passenger P that downloading the content C different from the contents C1 to C4 being output in advance is recommended.

In a case of YES in step S207, the process proceeds to step S219.

For convenience, in a case of YES in step S207, a case will be described in which the notification unit 215 determines that the scheduled output period RP for each of the contents C1 to C4 overlaps the period in which the poor communication state CN is estimated.

Then, in step S219, the notification unit 215 classifies each of the contents C1 to C4 into a type of the contents C1 to C4, and the notification unit 215 sets a higher priority PR for the type of content as the number of passengers P to whom the content is output is larger, from among the types of contents C1 to C4. The priority PR is set to three levels, for example, “high”, “medium”, and “low”.

In step S221, the notification unit 215 determines whether the priority PR for each of the contents C1 to C4 is equal to or more than a threshold. The threshold indicates that the priority PR is “medium”, for example.

When the notification unit 215 determines that the priority PR is not equal to or more than the threshold (step S221; NO), the process proceeds to step S223.

Then, in step S223, the notification unit 215 determines that the notification content does not include the information related to the content C for which the priority PR is not equal to or more than the threshold, the process proceeds to step S227.

When the notification unit 215 determines that the priority PR is equal to or more than the threshold (step S221; YES), the process proceeds to step S225.

Then, in step S225, the notification unit 215 determines that the notification content includes the information related to the content C for which the priority PR is equal to or more than the threshold, the process proceeds to step S227. In step S225, for example, the notification unit 215 notifies the passenger P to urge the passenger P to download the content C for which the priority PR is equal to or more than the threshold.

Next, in step S227, the content control device 2B determines whether the driving of the vehicle 100 is ended.

When the content control device 2B determines that the driving of the vehicle 100 is not ended (step S227; NO), the process returns to step S201. When the content control device 2B determines that the driving of the vehicle 100 is ended (step S227; YES), the process then ends.

Steps S215, S217, S223, and S225 correspond to an example of a “notification step”.

### 2-4. Configurations and Effects

As described above with reference to FIGS. 7 to 10, in the content control device 2B according to the second embodiment, the content acquisition unit 211 acquires the plurality of contents C via the communication interface 23, the content output unit 212 outputs the plurality of contents C in association with each of the plurality of seats 1 of the vehicle 100, the content storage unit 221 stores the plurality of contents C acquired by the content acquisition unit 211, the output status acquisition unit 213 estimates the scheduled output period RP indicating a period until scheduled date and time when the output of each of the plurality of contents C acquired by the content acquisition unit 211 ends, and when there are the plurality of contents C for which the scheduled output period RP overlaps the period in which the poor communication state CN is estimated, the notification unit 215 sets the priority PR for each of the plurality of contents C and determines the notification content according to the priority PR.

According to such a configuration, when there are the plurality of contents C for which the scheduled output period RP overlaps the period in which the poor communication state CN is estimated, the priority PR is set for each of the plurality of contents C, and the notification content is determined according to the priority PR. Therefore, the priority PR is appropriately set, whereby when there are the plurality of contents C for which the scheduled output period RP overlaps the period in which the poor communication state CN is estimated, an appropriate notification content can be determined.

In the content control device 2B, when there are the plurality of contents C for which the scheduled output period RP overlaps the period in which the poor communication state CN is estimated, the notification unit 215 sets a higher priority PR for the content as the number of passengers P to whom the content is output is larger, from among the plurality of contents C, and determines the notification content according to the priority PR.

According to such a configuration, when there are the plurality of contents C for which the scheduled output period RP overlaps the period in which the poor communication state CN is estimated, the larger the number of passengers P to whom the content is output is, the higher the priority PR for the content is set, from among the plurality of contents C, whereby the priority PR can be appropriately set. In addition, the notification content is determined according to the priority PR set appropriately, and thus an appropriate notification content can be determined when there are the plurality of contents C for which the scheduled output period RP overlaps the period in which the poor communication state CN is estimated.

In the content control device 2B, when there are the plurality of contents C for which the scheduled output period RP overlaps the period in which the poor communication state CN is estimated, the notification unit 215 classifies each of the plurality of contents C into types of content C, and the notification unit 215 sets a higher priority PR for a type of content C as the number of passengers P to whom the content is output is larger, from among the types of content C to determine the notification content according to the priority PR.

According to such a configuration, when there are the plurality of contents C for which the scheduled output period RP overlaps the period in which the poor communication state CN is estimated, each of the plurality of contents C is classified into the types of content C, and the larger the number of passengers P to whom the content is output is, the higher the priority PR for the type of content C is set, from among the types of content C, whereby the priority PR can be appropriately set. In addition, the notification content is determined according to the priority PR set appropriately, and thus an appropriate notification content can be determined when there are the plurality of contents C for which the scheduled output period RP overlaps the period in which the poor communication state CN is estimated.

In the content control device 2B, when the scheduled output period RP of any of the plurality of contents C does not overlap the period in which the poor communication state CN is estimated, the notification unit 215 notifies of the content including the information related to the content C different from the content C being output.

According to such a configuration, when the scheduled output period RP of any of the plurality of contents C does not overlap the period in which the poor communication state CN is estimated, the display screen is displayed, as the notification content including the information related to the content C different from the content C being output, on the touch panel TP to urge to download the content C different from the content C being output. Therefore, the passenger P can know that it is necessary to download the content C different from the content C being output. Thus, it is possible to notify the passenger P of the vehicle 100 of appropriate content information.

When the history storage unit 224 that stores output histories HS of contents C of the plurality of passengers P seated on the plurality of seats 1 of the vehicle 100 is included in the content control device 2B, and the scheduled output period RP of any of the plurality of contents C does not overlap the period in which the poor communication state CN is estimated, the notification unit determines the content C different from the content C being output, based on the output history HS of the content of the corresponding passenger.

According to such a configuration, when the scheduled output period RP does not overlap the period in which the poor communication state CN is estimated, the content C different from the content C being output is determined based on the output history HS of the content C of the corresponding passenger P, and thus it is possible to determine, as the content C different from the content C being output, the content C that the passenger P desires to be output. Thus, the content C different from the content C being output can be appropriately determined.

In the content control device 2B, when the scheduled output period RP does not overlap the period in which the poor communication state CN is estimated, the notification unit 215 sets the priority PR according to the seat 1 on which each of the plurality of passengers P is seated, and determines whether to include the content C different from the content C being output in the notification content according to the priority PR.

According to such a configuration, when the scheduled output period RP does not overlap the period in which the poor communication state CN is estimated, the priority PR is set according to the seat 1 on which each of the plurality of passengers P is seated, and thus the priority PR can be appropriately set. In addition, whether to include the content C different from the content C being output in the notification content is determined according to the priority PR, and thus the notification content can include the content C corresponding to the seat 1 with a high priority PR and different from the content C being output. Therefore, the content C to be included in the notification content can be appropriately set.

When the driving mode detection unit 216 that detects the driving mode CV of the vehicle 100 is included in the content control device 2B, and the scheduled output period RP does not overlap the period in which the poor communication state CN is estimated, the notification unit 215 sets the priority PR for the seat 1 other than the first seat 11, which is the driver's seat, to be higher than that of the first seat 11 when the driving mode CV indicates the driving by the driver, and sets the priority PR for the seat 11, which is the driver's seat, to be higher than the priority PR for the seat 1 other than the first seat 11 when the driving mode CV indicates the automatic driving.

According to such a configuration, when the scheduled output period RP does not overlap the period in which the poor communication state CN is estimated, the priority PR for the seat 1 other than the first seat 11, which is the driver's seat, is set to be higher than the priority PR for the first seat 11 when the driving mode CV indicates the driving by the driver. Therefore, the priority PR can be appropriately set when the driving mode CV indicates the driving by the driver. In addition, when the scheduled output period RP does not overlap the period in which the poor communication state CN is estimated, the priority PR for the first seat 11, which is the driver's seat, is set to be higher than the priority PR for the seat 1 other than the first seat 11 when the driving mode CV indicates the automatic driving. Therefore, the priority PR can be appropriately set when the driving mode CV indicates the automatic driving. Thus, the priority PR for the seat 1 can be set appropriately according to the driving mode CV.

### 3. OTHER EMBODIMENTS

The above-described embodiments are preferred embodiments of the present invention. However, the present invention is not limited to the above-described embodiments, and various modifications are possible within the scope of the gist of the present invention.

In the present embodiments, a case has been described in which the seat 1 is composed of five seats, that is, the first seat 11, the second seat 12, the third seat 13, the fourth seat 14, and the fifth seat 15, but embodiments are not limited thereto. The seat 1 may be composed of three seats, for example. The seat 1 may be composed of four seats, for example. The seat 1 may be composed of six or more seats, for example.

In the present embodiments, a case has been described in which there are four passengers P, that is, the passenger PA, the passenger PB, the passenger PC, and the passenger PD, but embodiments are not limited thereto. There may be a plurality of passengers P. For example, there may be two passengers P. For example, there may be three passengers P. Furthermore, there may be five or more passengers P, for example.

In the present embodiment, a case has been described in which the communication state estimation unit 214 estimates the communication state CS of the communication interface 23 based on the route RT and the communication map information MP, for example, but embodiments are not limited thereto. The communication state estimation unit 214 may be communicably connected to the server device via, for example, the communication interface 23, acquire the communication map information MP, and estimate the communication state CS of the communication interface 23 based on the driving position and the communication map information MP.

In the present embodiment, a case has been described in which the output mechanism 3 includes the touch panel TP and the speaker SP, but embodiments are not limited thereto. For example, the touch panel TP and the speaker SP may be arranged separately.

For example, the content control device 2 illustrated in FIGS. 2 and 8 shows a functional configuration, and the specific implementation form is not particularly limited. In other words, it is not necessarily required to implement hardware corresponding to respective components, but it is of course possible to construct a configuration in which the functions of the respective components are implemented by executing a program by one processor. In addition, some of the functions implemented by software in the above-described embodiments may be implemented by hardware, or some of the functions implemented by hardware may be implemented by software.

Further, for example, the processing units in the flowcharts illustrated in FIGS. 6 and 10 are divided according to the main processing contents to make the processing of the content control device 2 easier to understand, and the present invention is not limited by the manner in which the processing units are divided or the names of the processing units illustrated in the flowcharts of FIGS. 6 and 10. The processing of the content control device 2 may be divided into more processing units depending on the processing contents, or one processing unit may be divided so as to include more processing. In addition, the processing order of the above flowchart is not also limited to the example illustrated in the drawings.

### 4. CONFIGURATIONS SUPPORTED BY EMBODIMENTS

The above-described embodiments are specific examples of the following configurations.

### Configuration 1

A content control device including: a content output unit that outputs a content to a passenger seated on a seat of a vehicle; an output status acquisition unit that acquires an output status of the content being output by the content output unit; a communication unit that communicates with an external device of the vehicle to acquire the content; a communication state estimation unit that estimates a communication state of the communication unit; a content storage unit that stores the content acquired by the communication unit; and a notification unit that notifies the passenger of information related to the content, in which, the notification unit varies a notification content depending on the output status of the content acquired by the output status acquisition unit and the communication state estimated by the communication state estimation unit.

According to the content control device of Configuration 1, since the notification content varies depending on the output status of the content and the communication state, it is possible to notify the passenger of the vehicle of appropriate content information. For example, depending on the output status of the content and the communication state, the display screen is displayed on the touch panel, and thus when the poor communication state occurs, it is possible to notify the passenger of the vehicle of appropriate content information.

### Configuration 2

In the content control device according to Configuration 1, when the communication state estimation unit estimates a poor communication state in which the communication unit is not capable of acquiring the content, the output status acquisition unit estimates a scheduled output period indicating a period until a scheduled date and time when an output of the content acquired by the communication unit ends, and the notification unit varies the notification content depending on whether the scheduled output period overlaps a period in which the poor communication state is estimated.

According to the content control device of Configuration 2, when the poor communication state is estimated in which the content cannot be acquired, the notification content varies depending on whether the scheduled output period overlaps the period in which the poor communication state is estimated, the scheduled output period indicating the period until the scheduled date and time when the output of the acquired content ends. For example, when the scheduled output period does not overlap the period in which the poor communication state is estimated, the display screen is displayed on the touch panel. In addition, when the scheduled output period overlaps the period in which the poor communication state is estimated, the display screen different from the above display screen is displayed on the touch panel. Therefore, when the poor communication state occurs, it is possible to notify the passenger of the vehicle of appropriate content information.

### Configuration 3

In the content control device according to Configuration 2, when the scheduled output period overlaps the period in which the poor communication state is estimated, the notification unit notifies of a content including information related to a first content, which is a content being output by the content output unit.

According to the content control device of Configuration 3, when the scheduled output period overlaps the period in which the poor communication state is estimated by the communication state estimation unit, the notification unit displays, as the notification content including the information related to the first content, the display screen including the information to urge to download the first content on the touch panel. Therefore, the passenger can know that it is necessary to download the first content. Thus, when the poor communication state occurs, it is possible to notify the passenger of the vehicle of appropriate content information.

### Configuration 4

In the content control device according to Configuration 2 or 3, when the scheduled output period ends within the period in which the poor communication state is estimated, the notification unit notifies of a content including information related to the first content and a second content, which is different from the first content and is output after the output of the first content ends by the content output unit.

According to the content control device of Configuration 4, when the scheduled output period ends within the period in which the poor communication state is estimated, the notification unit displays, as the notification content including the information related to the first content and the second content, the display screen including the information to urge to download the first content and the second content on the touch panel. Therefore, the passenger can know that it is necessary to download the first content and the second content. Thus, when the poor communication state occurs, it is possible to notify the passenger of the vehicle of appropriate content information.

### Configuration 5

In the content control device according to any one of Configurations 2 to 4, when the scheduled output period ends within the period in which the poor communication state is estimated, the notification unit estimates a shortage period, which is a period in which the content output by the content output unit is short, based on the period in which the poor communication state is estimated and the scheduled output period, and notifies, as the second content, of a content having an output period longer than the shortage period.

According to the content control device of Configuration 5, when the scheduled output period ends within the period in which the poor communication state is estimated, the shortage period is estimated based on the period in which the poor communication state is estimated and the scheduled output period, and the content having the output period longer than the shortage period is notified as the second content. For example, the display screen is displayed on the touch panel to urge to download the first content and the second content having the output period longer than the shortage period. Therefore, the passenger can know that it is necessary to download the first content and the second content, which has the output period longer than the shortage period. Thus, when the poor communication state occurs, it is possible to notify the passenger of the vehicle of appropriate content information.

### Configuration 6

In the content control device according to any one of Configurations 2 to 5, the content output unit outputs the plurality of contents in association with each of a plurality of seats of the vehicle, the communication unit acquires a plurality of contents, the content storage unit stores the plurality of contents acquired by the communication unit, the output status acquisition unit estimates a scheduled output period indicating a period until a scheduled date and time when an output of each of the plurality of contents acquired by the communication unit ends, and when there are a plurality of contents for which the scheduled output period overlaps the period in which the poor communication state is estimated, the notification unit sets a priority for each of the plurality of contents and determines a notification content according to the priority.

According to the content control device of Configuration 6, when there are the plurality of contents for which the scheduled output period overlaps the period in which the poor communication state is estimated, the priority is set for each of the plurality of contents, and the notification content is determined according to the priority. Therefore, the priority is appropriately set, whereby when there are the plurality of contents for which the scheduled output period overlaps the period in which the poor communication state is estimated, an appropriate notification content can be determined.

### Configuration 7

In the content control device according to Configuration 6, when there are the plurality of contents for which the scheduled output period overlaps the period in which the poor communication state is estimated, the notification unit sets a higher priority for a content as the number of passengers to whom the content is output is larger, from among the plurality of contents to determine a notification content according to the priority.

According to the content control device of Configuration 7, when there are the plurality of contents for which the scheduled output period overlaps the period in which the poor communication state is estimated, the larger the number of passengers to whom the content is output is, the higher the priority for the content is set, from among the plurality of contents, whereby the priority can be appropriately set. In addition, the notification content is determined according to the priority set appropriately, and thus an appropriate notification content can be determined when there are the plurality of contents for which the scheduled output period overlaps the period in which the poor communication state is estimated.

### Configuration 8

In the content control device according to Configuration 6 or 7, when there are the plurality of contents for which the scheduled output period overlaps the period in which the poor communication state is estimated, the notification unit classifies each of the plurality of contents into types of content, and the notification unit sets a higher priority for a type of content as the number of passengers to whom the content is output is larger, from among the types of content to determine a notification content according to the priority.

According to the content control device of Configuration 8, when there are the plurality of contents for which the scheduled output period overlaps the period in which the poor communication state is estimated, each of the plurality of contents is classified into the types of content, and the larger the number of passengers to whom the content is output is, the higher the priority for the type of content is set, from among the types of content, whereby the priority can be appropriately set. In addition, the notification content is determined according to the priority set appropriately, and thus an appropriate notification content can be determined when there are the plurality of contents for which the scheduled output period overlaps the period in which the poor communication state is estimated.

### Configuration 9

In the content control device according to any one of Configurations 6 to 8, when the scheduled output period of any of the plurality of contents does not overlap the period in which the poor communication state is estimated, the notification unit notifies of a content including information related to a content different from a content being output.

According to the content control device of Configuration 9, when the scheduled output period of any of the plurality of contents does not overlap the period in which the poor communication state is estimated by the communication state estimation unit, the display screen is displayed, as the notification content including the information related to the content different from the content being output, on the touch panel to urge to download the content different from the content being output. Therefore, the passenger can know that it is necessary to download the content different from the content being output. Thus, it is possible to notify the passenger of the vehicle of appropriate content information.

### Configuration 10

In the content control device according to any one of Configurations 6 to 9, the content control device further includes a history storage unit that stores an output history of a content of a plurality of passengers seated on the plurality of seats of the vehicle, and when the scheduled output period of any of the plurality of contents does not overlap the period in which the poor communication state is estimated, the notification unit determines the content different from the content being output, based on the output history of the content of the corresponding passenger.

According to the content control device of Configuration 10, when the scheduled output period does not overlap the period in which the poor communication state is estimated, the content different from the content being output is determined based on the output history of the content of the corresponding passenger, and thus it is possible to determine, as the content different from the content being output, the content that the passenger desires to be output. Thus, the content different from the content being output can be appropriately determined.

### Configuration 11

In the content control device according to any one of Configurations 6 to 10, when the scheduled output period of any of the plurality of contents does not overlap the period in which the poor communication state is estimated, the notification unit sets the priority according to the seat on which each of the plurality of passengers is seated, and determines whether to include the content different from the content being output in the notification content according to the priority.

According to the content control device of Configuration 11, when the scheduled output period does not overlap the period in which the poor communication state is estimated, the priority is set according to the seat on which each of the plurality of passengers is seated, and thus the priority can be appropriately set. In addition, whether to include the content different from the content being output in the notification content is determined according to the priority, and thus the notification content can include the content corresponding to the seat with a high priority and different from the content being output. Therefore, the content to be included in the notification content can be appropriately set.

### Configuration 12

In the content control device according to any one of Configurations 6 to 11, the content control device further includes a driving mode detection unit that detects a driving mode of the vehicle, and when the scheduled output period of any of the plurality of contents does not overlap the period in which the poor communication state is estimated, the notification unit sets the priority for a seat other than a driver's seat to be higher than the priority for the driver's seat when the driving mode indicates driving by a driver, and sets the priority for the driver's seat to be higher than the priority for the seat other than the driver's seat when the driving mode indicates automatic driving.

According to the content control device of Configuration 12, when the scheduled output period does not overlap the period in which the poor communication state is estimated, the priority for the seat other than the driver's seat is set to be higher than the priority for the driver's seat when the driving mode indicates the driving by the driver. Therefore, the priority can be appropriately set when the driving mode indicates the driving by the driver. In addition, when the scheduled output period does not overlap the period in which the poor communication state is estimated, the priority for the driver's seat is set to be higher than the priority for the seat other than the driver's seat when the driving mode indicates the automatic driving. Therefore, the priority can be appropriately set when the driving mode indicates the automatic driving. Thus, the priority for the seat can be set appropriately according to the driving mode.

### Configuration 13

A content control method performed by a content control device, the content control device including: a content output unit that outputs a content to a passenger seated on a seat of a vehicle; an output status acquisition unit that acquires an output status of the content being output by the content output unit; a communication unit that communicates with an external device of the vehicle to acquire the content; a communication state estimation unit that estimates a communication state of the communication unit; a content storage unit that stores the content acquired by the communication unit; and a notification unit that notifies the passenger of information related to the content, in which, the notification unit executes a notification step of varying a notification content depending on the output status of the content acquired by the output status acquisition unit and the communication state estimated by the communication state estimation unit.

The content control method of Configuration 13 has the same configuration as the content control device of Configuration 1, and thus has the same operational effects as the content control device of Configuration 1.

### Configuration 14

A content control program that causes a processor provided in a content control device arranged in a vehicle to function as: a content output unit that outputs a content to a passenger seated on a seat of the vehicle; an output status acquisition unit that acquires an output status of the content being output by the content output unit; a communication unit that communicates with an external device of the vehicle to acquire the content; a communication state estimation unit that estimates a communication state of the communication unit; a content storage unit that stores the content acquired by the communication unit; and a notification unit that notifies the passenger of information related to the content, in which, the notification unit varies a notification content depending on the output status of the content acquired by the output status acquisition unit and the communication state estimated by the communication state estimation unit.

The content control program of Configuration 14 has the same configuration as the content control device of Configuration 1, and thus has the same operational effects as the content control device of Configuration 1.

### REFERENCE SIGNS LIST

100 vehicle
1 seat
11 first seat
12 second seat
13 third seat
14 fourth seat
15 fifth seat
2, 2A, 2B content control device
21 processor
211 content acquisition unit (part of communication unit)
212 content output unit
213 output status acquisition unit
214 communication state estimation unit
215 notification unit
216 driving mode detection unit
22 memory
221 content storage unit
222 route storage unit
223 map storage unit
224 history storage unit
23 communication interface (part of communication unit)
3 output mechanism
31 first output mechanism
311 first touch panel
312 first speaker
32 second output mechanism
321 second touch panel
322 second speaker
33 third output mechanism
331 third touch panel
332 third speaker
35 fifth output mechanism
351 fifth touch panel
352 fifth speaker
5 server device
51 first server device
52 second server device
53 third server device
54 fourth server device
C, C1, C2, C3, C4 content
C1 first content
C2, C2A, C2B, C2C second content
CG good communication state
CN poor communication state
CS communication state
CV driving mode
HS output history
MP communication map information
P, PA, PB, PC, PD passenger
PG control program (content control program)
PR priority
PS shortage period
RP scheduled output period
SP speaker
TBL1 first table
TBL2 second table
TP touch panel

1. A content control device comprising:
a content output unit that outputs a content to a passenger seated on a seat of a vehicle;
an output status acquisition unit that acquires an output status of the content being output by the content output unit;
a communication unit that communicates with an external device of the vehicle to acquire the content;
a communication state estimation unit that estimates a communication state of the communication unit;
a content storage unit that stores the content acquired by the communication unit; and
a notification unit that notifies the passenger of information related to the content, wherein
the notification unit varies a notification content depending on the output status of the content acquired by the output status acquisition unit and the communication state estimated by the communication state estimation unit.

2. The content control device according to claim 1, wherein
when the communication state estimation unit estimates a poor communication state in which the communication unit is not capable of acquiring the content,
the output status acquisition unit estimates a scheduled output period indicating a period until a scheduled date and time when an output of the content acquired by the communication unit ends, and
the notification unit varies the notification content depending on whether the scheduled output period overlaps a period in which the poor communication state is estimated.

3. The content control device according to claim 2, wherein
when the scheduled output period overlaps the period in which the poor communication state is estimated,
the notification unit notifies of a content including information related to a first content, which is a content being output by the content output unit.

4. The content control device according to claim 3, wherein
when the scheduled output period ends within the period in which the poor communication state is estimated,
the notification unit notifies of a content including information related to the first content and a second content, which is different from the first content and is output after the output of the first content ends by the content output unit.

5. The content control device according to claim 4, wherein
when the scheduled output period ends within the period in which the poor communication state is estimated,
the notification unit estimates a shortage period, which is a period in which the content output by the content output unit is short, based on the period in which the poor communication state is estimated and the scheduled output period, and
the notification unit notifies, as the second content, of a content having an output period longer than the shortage period.

6. The content control device according to claim 2, wherein
the communication unit acquires a plurality of contents,
the content output unit outputs the plurality of contents in association with each of a plurality of seats of the vehicle,
the content storage unit stores the plurality of contents acquired by the communication unit,
the output status acquisition unit estimates a scheduled output period indicating a period until a scheduled date and time when an output of each of the plurality of contents acquired by the communication unit ends, and
when there are a plurality of contents for which the scheduled output period overlaps the period in which the poor communication state is estimated,
the notification unit sets a priority for each of the plurality of contents and determines a notification content according to the priority.

7. The content control device according to claim 6, wherein
when there are the plurality of contents for which the scheduled output period overlaps the period in which the poor communication state is estimated,
the notification unit sets a higher priority for a content as a number of passengers to whom the content is output is larger, from among the plurality of contents to determine a notification content according to the priority.

8. The content control device according to claim 6, wherein
when there are the plurality of contents for which the scheduled output period overlaps the period in which the poor communication state is estimated,
the notification unit classifies each of the plurality of contents into types of content, and
the notification unit sets a higher priority for a type of content as a number of passengers to whom a content is output is larger, from among the types of content to determine a notification content according to the priority.

9. The content control device according to claim 6, wherein
when the scheduled output period of any of the plurality of contents does not overlap the period in which the poor communication state is estimated,
the notification unit notifies of a content including information related to a content different from a content being output.

10. The content control device according to claim 9, further comprising:
a history storage unit that stores an output history of a content of a plurality of passengers seated on the plurality of seats of the vehicle, wherein
when the scheduled output period of any of the plurality of contents does not overlap the period in which the poor communication state is estimated,
the notification unit determines the content different from the content being output, based on the output history of the content of the corresponding passenger.

11. The content control device according to claim 10, wherein
when the scheduled output period of any of the plurality of contents does not overlap the period in which the poor communication state is estimated,
the notification unit sets the priority according to the seat on which each of the plurality of passengers is seated, and
the notification unit determines whether to include the content different from the content being output in the notification content according to the priority.

12. The content control device according to claim 11, further comprising:
a driving mode detection unit that detects a driving mode of the vehicle, wherein
when the scheduled output period of any of the plurality of contents does not overlap the period in which the poor communication state is estimated,
the notification unit sets the priority for a seat other than a driver's seat to be higher than the priority for the driver's seat when the driving mode indicates driving by a driver, and
the notification unit sets the priority for the driver's seat to be higher than the priority for the seat other than the driver's seat when the driving mode indicates automatic driving.

13. A content control method performed by a content control device,
the content control device including:
a content output unit that outputs a content to a passenger seated on a seat of a vehicle;
an output status acquisition unit that acquires an output status of the content being output by the content output unit;
a communication unit that communicates with an external device of the vehicle to acquire the content;
a communication state estimation unit that estimates a communication state of the communication unit;
a content storage unit that stores the content acquired by the communication unit; and
a notification unit that notifies the passenger of information related to the content, wherein
the notification unit executes a notification step of varying a notification content depending on the output status of the content acquired by the output status acquisition unit and the communication state estimated by the communication state estimation unit.

14. A non-transitory computer readable storage medium storing a content control program that causes a processor provided in a content control device arranged in a vehicle to function as:
a content output unit that outputs a content to a passenger seated on a seat of the vehicle;
an output status acquisition unit that acquires an output status of the content being output by the content output unit;
a communication unit that communicates with an external device of the vehicle to acquire the content;
a communication state estimation unit that estimates a communication state of the communication unit;
a content storage unit that stores the content acquired by the communication unit; and
a notification unit that notifies the passenger of information related to the content, wherein
the notification unit varies a notification content depending on the output status of the content acquired by the output status acquisition unit and the communication state estimated by the communication state estimation unit.
